(19) United States
(12) Patent Application Publication
(10) Pub. No.: US 2020/0412219 A1
(43) Pub. Date: Dec. 31, 2020

(54) Electromagnetic Actuator

(71) Applicant: AAC Technologies Pte. Ltd., Singapore city (SG)

(72) Inventors: Keyong Zhou, Shenzhen (CN); Yayu Wang, Shenzhen (CN); Xudong Yan, Shenzhen (CN); Wei Liu, Shenzhen (CN)

(21) Appl. No.: 16/994,655

(22) Filed: Aug. 16, 2020

Related U.S. Application Data
(63) Continuation of application No. PCT/CN2019/094020, filed on Jun. 29, 2019.

(51) Int. Cl. H02K 33/02

(52) U.S. Cl. CPC H02K 33/02

(57) ABSTRACT

The present invention provides an electromagnetic actuator which includes a housing body having an accommodation space, a stator accommodated in the accommodation space, a vibrator arranged opposite to the stator with distance and an elastic assembly suspending the vibrator in the accommodation space. The elastic assembly comprises two springs in a planar structure, and the two springs are respectively provided on opposite sides of the vibrator along the vibration direction of the vibrator. Each of the springs is fixedly connected to the vibrator and extended to be fixed at the housing body. Compared with the related technology, the electromagnetic actuator of the present invention has good vibration stability and better vibration performance.

### FIELD OF THE PRESENT DISCLOSURE

The present invention relates to electroacoustic conversion field, in particular to a portable electromagnetic actuator.

### DESCRIPTION OF RELATED ART

With the advent of the mobile Internet era, the number of smart mobile terminals is increasing continuously. Among many mobile devices, a mobile phone is undoubtedly the most common and portable mobile terminal. At present, it is a new trend for mobile phones to make sound through the screen, and electromagnetic actuator is one of the key components for screen sound, so with the rapid application of screen sound technology, high-performance electromagnetic actuator has become particularly important.

The electromagnetic actuator of the related art comprises a housing body having an accommodation space, a stator and a vibrator housed within the accommodation space, and a spring suspending the vibrator within the accommodation space.

However, in the electromagnetic actuator of the related art, the spring mostly adopts a single spring with a planar structure, and the linearity for the spring stiffness is poor and the symmetry is not good in the vibration direction of the vibrator, thus influencing the driving effect of the magnetic exciter.

Therefore, it is necessary to provide a new electromagnetic actuator to solve the above technical problems.

### SUMMARY OF THE INVENTION

One of the main objects of the present invention is to provides an electromagnetic actuator with improved vibration stability and vibration performance.

Accordingly, the present invention provides an electromagnetic actuator which includes a housing body having an accommodation space, a stator accommodated in the accommodation space, a vibrator arranged opposite to the stator with distance and an elastic assembly suspending the vibrator in the accommodation space. The elastic assembly comprises two springs in a planar structure, and the two springs are respectively provided on opposite sides of the vibrator along the vibration direction of the vibrator. Each of the springs is fixedly connected to the vibrator and extended to be fixed at the housing body. Compared with the related technology, the electromagnetic actuator of the present invention has good vibration stability and better vibration performance.

As an improvement, the elastic assemblies comprise two groups respectively located on two opposite sides of the vibrator along a direction perpendicular to the vibration direction.

As an improvement, the vibrator comprises the magnet assembly having main magnets respectively provided on two opposite sides of the stator along a first direction, each of two groups of the elastic assemblies support and suspend one of the main magnets within the accommodation space, and the two springs of the same group of the elastic assemblies are respectively fixed on two opposite sides of the main magnets along the vibration direction.

As an improvement, the elastic assembly further comprises a connector fixed to a side of the second fixing arm away from the main magnet; the connector is fixedly connected to the housing body; and the spring is fixedly connected to the housing body through the connector.

As an improvement, the elastic assembly further comprises a support block clamped between two second fixing arms at the same ends of the two springs; and both the two second fixing arms are fixedly connected to the support block.

As an improvement, the stator comprises the coil assembly having an iron core supported on the housing body, and a coil sheathed wound around the iron core along the vibration direction; the winding plane of the coil is perpendicular to the vibration direction; the magnetizing direction of the main magnets is perpendicular to the vibration direction, and the ends of the main magnets facing the coil have the same polarity.

As an improvement, the magnet assembly further comprises a plurality of secondary magnets provided respectively on two opposite sides of the stator along a second direction different from the second direction; the end of the main magnets facing the stator and the end of the secondary magnets facing the stator have the same polarities.

As an improvement, the vibrator further comprises a plurality of support plates fixed to the main magnets as a cover, the first fixing arm is fixed on one side of the support plates away from the main magnet, the main magnets and the secondary magnets are both fixed on the side of the support plates near the coil assembly.

As an improvement, the support plates comprise two support plates, the two support plates are respectively located on the two opposite sides of the main magnets along the vibration direction, the magnet assembly is clamped between the two support plates.

As an improvement, the vibrator further comprises weight members attached to the main magnets and the secondary magnet; the weight members are located on one side of the main magnets away from the stator and one side of the secondary magnets away from the stator; and the weight members are clamped between the two support plates.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of an electromagnetic actuator in accordance with an exemplary embodiment of the present invention;

FIG. 2 is a partially exploded view of the electromagnetic actuator in FIG. 1;

FIG. 3 is a cross-sectional view of the electromagnetic actuator taken along line A-A in FIG. 1;

FIG. 4 is a cross-sectional view of the electromagnetic actuator taken along line B-B in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

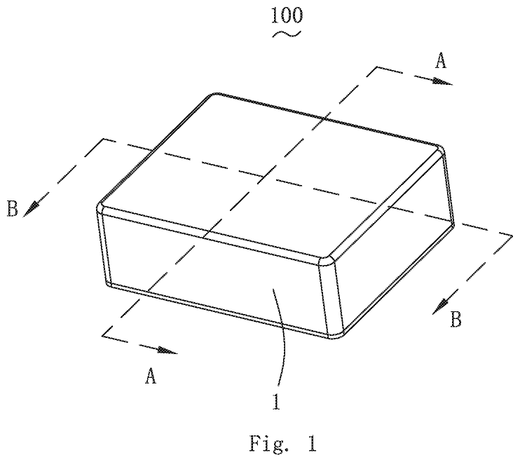

Referring to FIGS. 1-4, the present invention provides an electromagnetic actuator 100 comprising a housing body 1 having an accommodation space 10, a stator 2 and a vibrator 3 accommodated in the accommodation space 10, and elastic assemblies 4. The vibrator 3 is arranged opposite to the stator 2 with distance, and the elastic assemblies are fixedly connected to the housing body and the vibrator 3 respectively; thereby suspending the vibrator 3 within the accommodation space 10. After being energized, the electromagnetic field formed between the stator 2 and the vibrator 3 interacts, so that the vibrator 3 performs linear reciprocating motion under the support of the elastic assemblies 4 to realize vibration.

One of the vibrator 3 and the stator 2 comprises a magnet assembly and the other comprises a coil assembly.

Specifically, the stator 2 comprises a coil assembly comprising an iron core 21 supported on the housing body 1 and a coil 22 sleeved on the iron core 21 along the vibration direction. The winding plane of the coil 22 is perpendicular to the vibration direction. More preferably, in this embodiment, the stator 2 also comprises two first magnetism conductive sheets 23. The first magnetism conductive sheets 23 are respectively sleeved on two opposite ends of the stator 2 along the vibration direction of the vibrator 3, thereby forming a clamp to the coil 22. The first magnetism conductive sheets 23 are mainly used for preventing the magnetic field from diffusing and leaking, and improving the driving force of the vibrator 3.

The vibrator 3 comprises a magnet assembly comprising main magnets 31 and secondary magnets 32, and the vibrator 3 further comprises support plates 33, weight members 34 and second magnetism conductive sheets 35.

The main magnets 31 comprise two main magnets, the two main magnets are respectively provided on the two opposite sides of the stator 2 along a first direction, the magnetizing direction of the main magnets 31 being perpendicular to the vibration direction, and one end of the main magnets 31 facing the coil 22 having the same polarity. The secondary magnets 32 comprise two secondary magnets, the secondary magnets are respectively provided on the two opposite sides of the stator 2 along a second direction, the first direction being different from the second direction, such as that the first direction and the second direction are mutually perpendicular, and the first direction and the second direction are both perpendicular to the vibration direction. That is, the main magnets 31 and the secondary magnets 32 are formed to be staggered and formed to be provided with distance around the stator 2. In this embodiment, one end of the main magnets 31 facing the stator 2 and one end of the secondary magnets 32 facing the stator 2 have the same polarity.

The support plates 33 are fixed on the main magnets 31 as a cover for forming a magnetic conductive structure, thereby reducing the diffusion leakage of the magnetic field and improving the vibration performance of the vibrator 3 to a certain extent.

In this embodiment, the secondary magnets 32 are also fixed to the support plates 33. The secondary magnets 32 and the main magnets 31 are both located on the same side of the support plates 33; namely, the main magnets 31 and the secondary magnets 32 are both fixed on the side of the support plates 33 near the coil assembly.

Preferably, the support plates 33 comprise two support plates, the two support plates 33 are respectively located on two opposite sides of the main magnets 31 along the vibration direction of the vibrator 3. The magnet assembly is clamped between the two support plates 33. The two support plates 33 is provided to reduce the leakage of magnetic field to a greater extent.

The weight members 34 comprise a plurality of weight members attached to the main magnets 31 and the secondary magnets 32 for increasing the mass of the vibrator 3, thereby effectively increasing the vibration performance of the vibrator 3.

In this embodiment, the weight members 34 are provided on one side of the main magnets 31 away from the stator 2 and on one side of the secondary magnets 32 away from the stator 2. The weight members 34 are clamped between the two support plates 33.

The second magnetism conductive sheets 35 are mainly attached to the main magnets 31 and the secondary magnets 32, and are also used for conducting magnetism, reducing magnetic field leakage, and further improving the vibration performance of the vibrator 3.

For example, the second magnetism conductive sheets 35 may be attached to the side of the main magnets 31 near the stator 2, between the main magnets 31 and the weight members 34. The secondary magnets 32 is close to the side of the stator 2, the secondary magnets 32 is far away from the side of the stator 2, and so on.

The elastic assemblies 4 comprise two spring 41, a connector 42 and a support block 43 in a planar structure.

The two spring 41 are respectively provided on two opposite sides of the vibrator 3 along the vibration direction of the vibrator 3, and each of the spring 41 is fixedly connected to the vibrator 3 and extended to be fixed to the housing body 1; so that the vibrator 3 is supported and suspended within the accommodation space 10.

The structure of the elastic assemblies 4 forms an upper plane and a lower plane, forming a clamp and elastic support of the vibrator 3, so that the stiffness of the elastic assemblies 4 is obviously enhanced with better reliability, and the vibration balance of the vibrator 3 is better.

The position where the spring 41 is connected to the vibrator 3 is not limited, which can be connected to the main magnets 31 or the secondary magnets 32, or even to the weight members 34, all such are feasible.

Specifically, in the present embodiment, the spring 41 comprises a first fixing arm 411, two spring arms 412 extended from the first fixing arms 411 towards both ends and provided suspended, and a second fixing arm 413 respectively extended from the two spring arms 412.

The first fixing arm 411 is fixedly connected to the main magnets 31 to form a direct connection to the main magnets 31, and the second fixing arm 413 is fixedly connected to the housing body 1, thereby enabling the vibrator 3 to be supported suspended in the accommodation space 10, providing its vibration conditions.

Of course, the first fixing arm 411 can also form an indirect connection to the main magnets 31, that is, the first fixing arm 411 is fixed to the support plates 33, and the support plates 33 are fixed to the main magnets 31, thereby realizing an indirect fixed connection between the first fixing arm 411 and the main magnets 31. For example, the first fixing arm 411 is fixed to one side of the support plates 33 away from the main magnets 31.

The connector 42 is fixed on one side of the second fixing arm 413 away from the main magnets 31, and the connector 42 is fixedly connected to the housing body 1. The spring 41 is fixedly connected to the housing body 1 through the connector 42. Therefore, in the present embodiment, for the two spring 41 of one set of the elastic assemblies 4, four of the connectors 42 are more preferably provided.

The support block 43 is clamped between two second fixing arm 413 at the same end of the two spring 41, and both the second fixing arm 413 are fixedly connected to the support block 43, thereby forming a fixing and strengthening effect on the second fixing arm 413, and further improving the reliability of the vibrator 3 when vibrating.

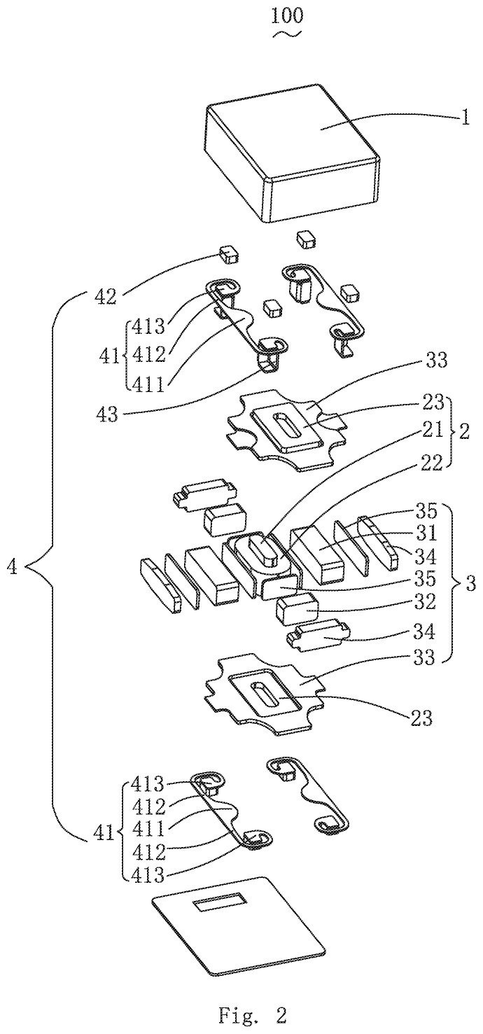

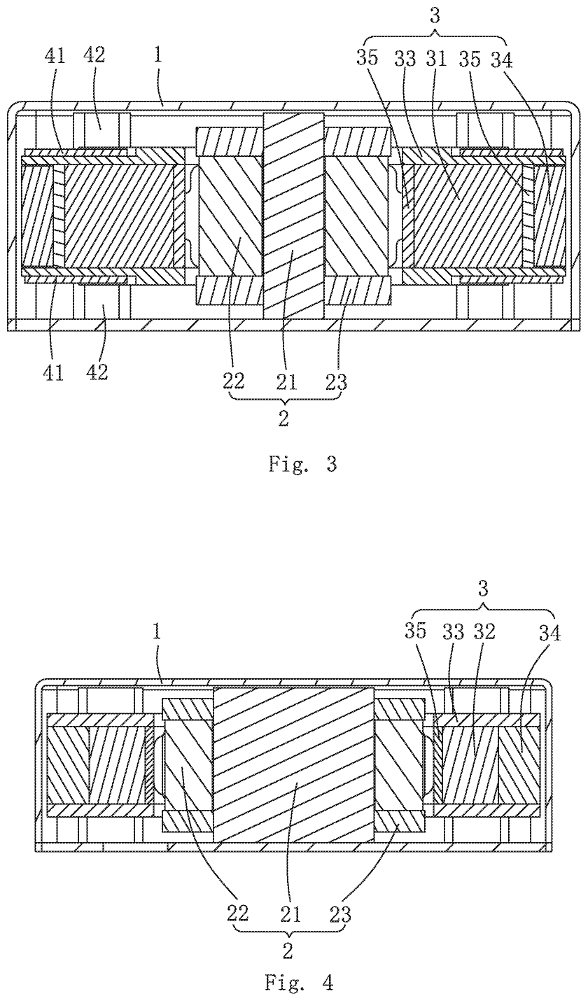

In the present embodiment, the elastic assemblies 4 comprise two sets, and the two sets of the elastic assemblies 4 are respectively positioned on the two opposite sides of the vibrator 3 along a vibration direction perpendicular to the vibrator 3. As shown in FIG. 2 and FIG. 3, the two sets of the elastic assemblies 4 are respectively located on the left and right sides of the vibrator 3, and each set of the elastic assembly 4 comprises the upper and lower spring 41. That is, it forms a symmetrical support structure of the four springs 41.

Two sets of the elastic assemblies 4 each supports and suspends one of the main magnets within the accommodation space, and the two springs of the same set of the elastic assemblies are respectively fixed on the two opposite sides of the main magnets along the vibration direction.

Compared with the elastic part of a single-plane structure of related art, under the same stroke, the maximum stress of the elastic assemblies 4 of the electromagnetic actuator 100 of the present invention is obviously smaller than that of the single-plane elastic part structure of related art, and can be reduced by more than 100%; and the difference between the second mode and the first mode of the elastic assemblies 4 is obviously increased, which is more than 1700% higher than that of a single-plane elastic member.

Compared with the prior art, the elastic assembly of the electromagnetic actuator of the present application comprises two springs with planar structures; the two springs are separately arranged at two opposite sides of the vibrator along the vibration direction of the vibrator; each spring is fixedly connected with the vibrator and is fixed on the housing body in an extending manner; and the structures form an upper plane and a lower plane to clamp and elastically support the vibrator, so that the stiffness of the elastic assembly is obviously enhanced, the reliability is better, and moreover, the vibration balance of the vibrator is better, thereby effectively improving the vibration stability, the vibration effect and other performance of the electromagnetic actuator.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An electromagnetic actuator, comprising:
a housing body having an accommodation space;
a stator accommodated in the accommodation space;
a vibrator arranged opposite to the stator with a distance from the stator;
a plurality of elastic assemblies suspending the vibrator in the accommodation space;
one of the vibrator and the stator comprising a magnet assembly and the other comprising a coil assembly, wherein
the elastic assemblies comprise two springs in a planar structure respectively provided on two opposite sides of the vibrator along a vibration direction of the vibrator;
each of the springs is fixedly connected to the vibrator and is extended to be fixed at the housing body;
each of the springs comprises a first fixing arm connected to the vibrator, a spring arm extending from two opposite ends of the first fixing arm and suspended within the accommodation space, and a second fixing arm extending from the spring arm, the second fixing arm is fixedly connected to the housing body.

2. The electromagnetic actuator as described in claim 1, wherein the elastic assemblies comprise two groups respectively located on two opposite sides of the vibrator along a direction perpendicular to the vibration direction.

3. The electromagnetic actuator as described in claim 2, wherein the vibrator comprises the magnet assembly having main magnets respectively provided on two opposite sides of the stator along a first direction, each of two groups of the elastic assemblies support and suspend one of the main magnets within the accommodation space, and the two springs of the same group of the elastic assemblies are respectively fixed on two opposite sides of the main magnets along the vibration direction.

4. The electromagnetic actuator as described in claim 3, wherein the elastic assembly further comprises a connector fixed to a side of the second fixing arm away from the main magnet; the connector is fixedly connected to the housing body; and the spring is fixedly connected to the housing body through the connector.

5. The electromagnetic actuator as described in claim 4, wherein the elastic assembly further comprises a support block clamped between two second fixing arms at the same ends of the two springs; and both the two second fixing arms are fixedly connected to the support block.

6. The electromagnetic actuator as described in claim 3, wherein the stator comprises the coil assembly having an iron core supported on the housing body, and a coil sheathed wound around the iron core along the vibration direction; the winding plane of the coil is perpendicular to the vibration direction; the magnetizing direction of the main magnets is perpendicular to the vibration direction, and the ends of the main magnets facing the coil have the same polarity.

7. The electromagnetic actuator as described in claim 6, wherein the magnet assembly further comprises a plurality of secondary magnets provided respectively on two opposite sides of the stator along a second direction different from the first direction; the end of the main magnets facing the stator and the end of the secondary magnets facing the stator have the same polarities.

8. The electromagnetic actuator as described in claim 7, wherein the vibrator further comprises a plurality of support plates fixed to the main magnets as a cover, the first fixing arm is fixed on one side of the support plates away from the main magnet, the main magnets and the secondary magnets are both fixed on the side of the support plates near the coil assembly.

9. The electromagnetic actuator as described in claim 8, wherein the support plates comprise two support plates, the two support plates are respectively located on the two opposite sides of the main magnets along the vibration direction, the magnet assembly is clamped between the two support plates.

10. The electromagnetic actuator as described in claim 9, wherein the vibrator further comprises weight members attached to the main magnets and the secondary magnet; the weight members are located on one side of the main magnets away from the stator and one side of the secondary magnets away from the stator; and the weight members are clamped between the two support plates.
